(19) United States
(12) Patent Application Publication
(10) Pub. No.: US 2004/0236597 A1
(43) Pub. Date: Nov. 25, 2004

(54) Method of capacity marketing

(76) Inventor: Steven N. Brody, Indiana, PA (US)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(21) Appl. No.: 10/792,401

(22) Filed: Mar. 3, 2004

Related U.S. Application Data
(60) Provisional application No. 60/451,497, filed on Mar. 3, 2003.
(60) Provisional application No. 60/457,204, filed on Mar. 25, 2003.

(51) Int. Cl. G06F 17/60

(52) U.S. Cl. 705/1

(57) ABSTRACT

A method for marketing air travel services for a carrier in an air transportation system including purchasing a capacity unit from the carrier, wherein the capacity unit corresponds to a fixed distance of air travel to be traveled by a passenger of the carrier, offering for purchase the capacity unit as a commodity unit in a commodity market, and selling the commodity unit in the commodity market. The capacity unit may be a seat mile, wherein the seat mile has a seat cost associated therewith, and wherein the seat cost is determined by the cost to fly the passenger for one mile. The commodity unit is fungible between carriers, for various classes of service, and for non-air travel services. The commodity unit may be represented as a financial instrument having a fixed period of validity. The commodity unit is utilized to obtain the capacity unit within the air transportation system.

### CROSS REFERENCE TO RELATED APPLICATIONS

This application claims the benefit of Provisional Application No. 60/451,497, filed Mar. 3, 2003, entitled “Airline Management Business Method” and Provisional Application No. 60/457,204, filed Mar. 25, 2003, entitled “Capacity Marketing Business Method,” both of which are hereby incorporated by reference in their entirety.

### BACKGROUND OF THE INVENTION

1. Field of the Invention

The present invention relates to the purchase, marketing, and distribution of a capacity and, more specifically, to a capacity marketing solution for the air transportation industry.

2. Description of Related Art

The sales, marketing, and distribution of air travel services have traditionally been facilitated through a multi-channel distribution network consisting of:

1. direct sales by the carriers to businesses and consumers, mostly through their own reservation systems, such as SABRE® and others;

2. sales through travel agencies, which provide travel information, pricing, scheduling, and booking assistance for which the carriers pay a commission; and

3. sales through wholesalers and vacation travel packagers affiliated with large corporations, hotels, resorts, and consumer marketing agencies.

In recent years, coinciding with the rise of the Internet, on-line travel and booking agencies have emerged, adding another channel to the traditional air transportation marketing and distribution network model. Indeed, as a method to recapture some of the distribution profits from their own ticket sales, several carriers have invested in or partnered with on-line travel agencies.

Since the deregulation of the air transportation industry in the late 1970s, carriers have been forced to struggle with a number of factors for which they were not prepared under government regulation in the 1950s, 1960s and 1970s. Moreover, the managements of these businesses were not equipped to deal with the challenges of aggressive marketing, unpredictable sales volumes, and expanding consumer choices as new carriers entered the market with low-priced promotional fares. Further complicating these competitive dynamics were the rising costs of fuel, new environmental regulations ranging from noise abatement to fueling protocols, and the entry of low labor cost single route competitors.

While the overall industry was trying to adapt to the market turmoil created by deregulation, the market for air travel continued to grow as the leisure and entertainment industries expanded, older Americans began retiring and traveling more, and business travel to meetings and conventions became a commonplace item in most corporate travel budgets. Accordingly, most established carriers were forced to purchase newer, more fuel efficient, environmentally compliant and technologically advanced aircraft well before the useful lives of their existing fleets had been expended. This premature replacement cycle, together with the rising costs of labor, fuel, taxes and airport landing fees, raised the fixed costs of a typical carrier operation while the industry itself could not consistently maintain pricing to cover this escalation of costs in highly competitive, deregulated markets.

Under regulation, the carriers were assured a consistent return on investment and a stable, regulated pricing mechanism to achieve it. Like most utilities, the industry was able to recover its fixed costs and make a favorable or reasonably attractive return for its investors. Under deregulation and competition, the industry was forced to innovate, compete, or perish. Suddenly the airline industry found itself competing on price after its traditional methods of market differentiation had for 30 years been service. Cost structures changed radically to meet market demand and competitive challenges, while at the same time non-controllable mandated costs (such as noise abatement, environmental controls, and advanced safety equipment) had to be absorbed into fixed costs. It is understandable then that during the past 25 years of deregulation, there has been a continuous wave of mergers, bankruptcies, employee buyouts, emergences from bankruptcy, and new consolidations. The industry has remained financially anemic, and shown no consistent method for achieving stable profitability (with the notable exception of Southwest Airlines®). Additionally, the lack of marketing innovation and complete loss of control over revenue management (demand and pricing) has made the air transport business even more susceptible to financial stress during periods of sluggish economic activity and fundamental demand shifts caused by a myriad of factors after Sep. 11, 2001.

A logical outcome of the industry's ongoing failure to deploy innovative marketing strategies to meet the demands of deregulation is that over the years the major carriers have grown more dependent on the business traveler for the majority of their revenue. The air transportation industry's treatment of the business traveler has been predatory throughout the history of deregulation, starting in the late 1970s and continuing to the present. A “short notice” passenger, typically a business customer who must travel on less than seven days notice, will pay three or four times what a leisure fare passenger, giving several weeks or even months notice, has to pay for the same seat to the same destination via the same route. The pricing models of the major carriers are utilizing the business customer to subsidize all other classes of passengers expecting that a typical business traveler has little flexibility when making travel arrangements for important commercial purposes. For years, this has been the industry's response to make up for its lack of marketing innovation and inability to see airline travel in any fundamental new light.

The events of Sep. 11, 2001 caused a cataclysmic shift in the underlying demand elasticity assumptions that have historically enabled the industry to survive with its two tier (consumer versus business) pricing model. First, the demand for business travel has dropped sharply and possibly permanently as the risks and need for frequent business travel are being reassessed. Second, the increased awareness and need for security has forced businesses to consider other means of air transport as an alternative to major carriers. Given the years of predatory pricing directed at the business traveler, the rates for private air transportation do not look much more expensive when all the other service factors are considered (e.g., time saving, security, flexibility in scheduling, etc.).

The air transportation industry now finds itself at a precipice of unprecedented depth. A confluence of factors (declining demand, heightened perception of the risks of flying, delays and hassles caused by increased security measures, emergence of new low-cost carriers, increased airport taxes and fees, and low employee morale caused by layoffs and labor union conflicts) have threatened the industry's prospects for survival.

In spite of these stresses and the need to tap federal loan guarantees, the managements of the major carriers have done little to address the problems of revenue management in their turnaround/recovery plans and have instead looked to cost cutting and capacity reductions as a bridge solution to better times. This will not work. It is, therefore, desirable to overcome the above problem and others by providing a method to address the financial survival problems of the air transport industry.

### SUMMARY OF THE INVENTION

Accordingly, what is needed and has not heretofore been developed is a revenue and demand management solution that is cost-based in the practical realities of today's air transportation complexities but is also perceived as attractive and fair to the traveling public, both individual consumers and business travelers. Therefore, the present invention is a business method whereby any air transport carrier system (even one comprised of a single plane) can sell some or all of its capacity through a distribution network comprised of underwriters, wholesale distributors, and sales agents or their equivalents. The system can support an exchange-based post sale market by specifying and packaging the capacity sold by each carrier in common units of measure called “seat miles.” The exchange-based post sale market can be accessed by all participants in the distribution network, including an end-user (traveling passenger) of the “service commodity.” Carriers may wish to enter such a market to repurchase capacity in high demand periods; wholesalers and sales agents may wish to purchase and/or sell seat miles on behalf of large business customers or vacation packagers with rapidly fluctuating and seasonal needs. Consumers may even enter the market by bidding through on-line intermediaries.

A carrier can hedge the risk of excess capacity and mitigate the uncertainties about average market pricing, load factors, and cash flow by selling out future capacity in advance to an underwriter, who then redistributes in seat mile units to syndicated selling groups, agents, brokers, booking firms, and other interested parties. Bringing some of its future capacity off the market in advance affords the entire air transportation system a method to improve controls over revenue management and to market its capacity without forcing its best customers to subsidize its least reliable travelers. In general, the invention describes a risk hedging system to stabilize pricing and cyclicality for the air transportation system. Risk hedging has benefited other industries for many years through commodity trading and mercantile exchanges that allow growers and producers to recoup some of their fixed costs by laying off risk to speculators, investors, and manufacturers through exchange-based systems.

Additionally, the capacity marketing concepts represented herein may be applied to any end-use consumer situation where there is a need to market capacity (variable or fixed), such as common carriers, or to convert fixed capacity into presold revenue that would otherwise be lost.

These and other advantages of the present invention will be understood from the description of the desirable embodiments, taken with the accompanying drawings, wherein like reference numbers represent like elements throughout.

### BRIEF DESCRIPTION OF THE DRAWINGS

FIG. 1 is a flow diagram illustrating an exchange-based method for marketing and trading air transportation services in the form of seat mile units, in accordance with the present invention; and

FIG. 2 is a schematic diagram showing the transmutation of a capacity unit into a commodity unit, in accordance with the present invention.

### DESCRIPTION OF THE PREFERRED EMBODIMENTS

The present invention is a business method whereby the air transportation carrier system can commoditize and package some of its passenger carrying capacity for advance sale. The air transport carrier system thereby hedges some of its risks of operation and improves its overall ability to manage revenue and demand cycles for more consistent revenue generation versus available system capacity.

Within the scope of a methodology and unifying metric that is commonly accepted throughout the air transportation industry, individual carriers would price and package for sale and distribution a certain percentage of their current or planned future passenger carrying capacity. Thus, this type of service capacity, along with any other type of service capacity, may be partitioned into a more tangible and/or quantitative form, such as one or more capacity units. For example, the capacity with reference to passengers would be packaged and sold as capacity units and, more descriptively, as “passenger seat miles of capacity.”

The primary metrics of profitability in the air transportation business would then be the passenger seat miles flown and load factors. The cost structure of each carrier can be described in seat mile cost, i.e., the cost to fly one passenger for a mile, although it is to be understood that any unit of distance, e.g., kilometer, may be used when determining cost structure. The primary determinant of profitability for a carrier is the load factor. This metric represents the percentage of available seat miles flown by the carrier that are actually passenger occupied. Usually, the higher the load factor, the higher the operating profit margin for the given carrier system.

Seat miles and load factors may be tracked and analyzed by investors and industry analysts on an annual basis and by airline carrier operating managements on a daily, weekly, or monthly basis. The cost per seat mile and aggregate load factors for each carrier system reflect a combination of factors including, but not limited to, regional economic conditions, labor costs, the mix of cities and routes served, as well as the type, age, cost, and capacity of aircraft deployed in various markets. Thus, seat mile costs for a national carrier, such as United Airlines®, could be significantly higher than the seat mile costs for a specialized or regional carrier. Similarly, a carrier, such as Southwest Airlines®, could have a much lower seat mile cost in comparison with national and international carriers. In general, labor costs account for a large portion of the seat mile differentials among major carriers.

The invention described herein uses passenger seat miles as the common unit of measure to package and price air transportation, although it is to be understood that other units of measure, such as kilometers or flight hours, may also be used. For example, the direct air mileage between two locations, such as Pittsburgh and the New York metropolitan region, might be 250 miles as the ATA or carriers rate and measure route distance. A ticket sold on that route would thus be rated at 250 seat miles. Another direct air mileage, such as between New York to Spokane, Wash., may be 3,000 miles. By applying a seat mile rate to these distances, a mechanism emerges to rationally price air transportation. By making prices mileage sensitive, consumers and businesses can purchase their transportation by buying common units of measure and applying them to distances to be traveled. An example of this might be a business which knows its employees will likely travel 100,000 miles during a given period of time, but cannot accurately determine in advance when and where its employees will travel to. By purchasing seat miles in advance from a carrier, a group of carriers, a travel agency, an on-line intermediary, a travel broker, or other likely potential beneficiary of this invention, the traveler can ensure the cost of travel will be distance (mileage) based and guaranteed in advance. In this example, if the cost per seat mile is $0.25, then 100,000 miles purchased in advance would cost a business $25,000. Desirably, seat miles are fungible, so that they are valid on any route within the carrier's serving and affiliated systems. For example, using the previous exemplary numbers, the route of Pittsburgh to New York for a single business traveler would be $62.50 (i.e., $0.25×250 rated miles), whereas the route of New York to Spokane would be $750.00 (i.e., $0.25×3,000). If the single business traveler has 3,250 seat miles, he/she may theoretically take the Pittsburgh to New York trip as well the New York to Spokane trip, or the single business traveler may take the Pittsburgh to New York trip 13 times (i.e., 13×250). In any case, the single business traveler has 3,250 seat miles that he/she may apply to any routes offered within the carrier's system.

It should be understood that each carrier in the air transportation system may be free to price its seat miles as specific issuances. Accordingly, there would be United Airline® seat miles, American Airlines® seat miles, XYZ company, for example, seat miles. The seat miles may also have a notion of universality attached, as the seat miles may be exchangeable among carriers as well as among routes in a given system. Additionally, the seat miles can be fungible for various classes of service. For example, two seat miles for coach class air travel may be exchanged for one seat mile of first class air travel. Finally, seat miles can be ftmgible for non-air travel specific services packaged by travel brokers, such as hotel rooms, car rentals, or vacation packages. Like commodities and stock options, issued seat miles would have fixed periods of validity, resulting in the seat miles being either utilized or expiring without value. Thus, the seat miles may be considered perishable. Unlike frequent traveler miles, due to the seat miles being sold as freely tradable financial products, there are no restrictions, such as blackout dates, or other preemptive features.

Because the seat miles are fixed units of service, seat miles can be readily traded among consumers, agencies, agents, brokers, businesses, and the carriers themselves, in any way commodities can be traded. For example, American Airlines® January 2004 seat mile issuance expiring in April 2004 might be attractive to a buyer representing a special convention group traveling in late March. If the owner of the January issuance has not used the seat miles as planned, he/she may wish to offer them through the exchange-based system referenced above. Alternatively, American Airlines® itself may wish to repurchase some of the seats it has sold if it predicts that the economy is stronger than forecasted and load factors are increasing beyond estimates in the April time frame.

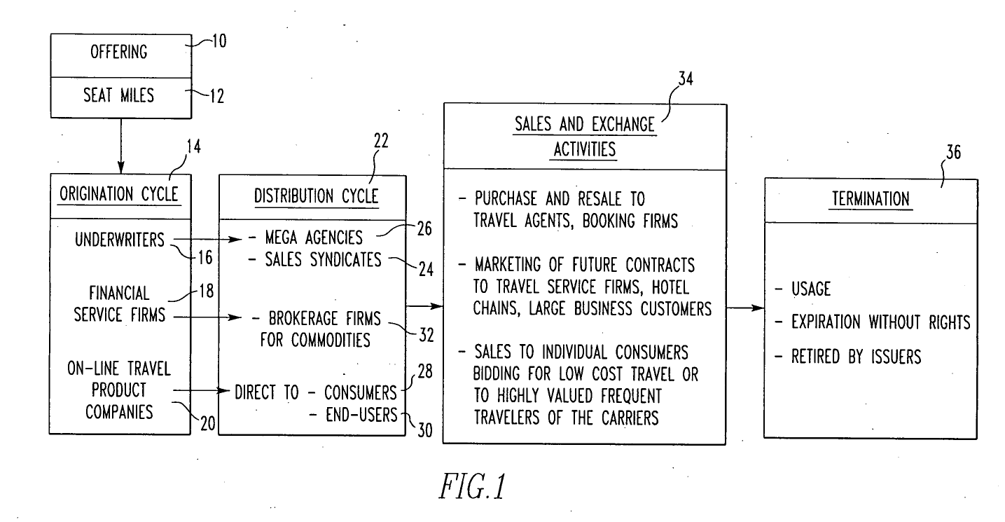

An exemplary capacity sale, in the context of an airline seat mile offering, will now be described. FIG. 1 depicts a flow diagram illustrating an exchange-based method for marketing and trading air transportation services in the form of seat mile units, in accordance with the present invention. An initial offering 10 is conducted by the owner (i.e., issuer) of a capacity, such as seat miles 12, who wishes to sell the seat miles 12 within the owner's system, such as the air transportation system. The carrier of the seat miles 12 may join other affiliated groups of carriers or compatible sellers of capacity that can be marketed or re-marketed through distribution and sales channels which facilitate capacity utilization via a flexible pricing environment, where real-time information-based auction/transaction activities dominate and facilitate the matching of buyers and sellers. The seat miles 12 are introduced into an origination cycle 14 through bulk sales to purchasers including, but not limited to, underwriters 16, financial service firms 18, and on-line travel companies 20. The purchasers may also be investment banks, brokerage houses, or similarly licensed entities with contacts, knowledge, and networks in place to conduct financial transactions with the public. Typically, a financial institution with brokerage and other distribution infrastructure to package, re-market, trade, sell, and process ultimate utilization of the capacity sold provides the financing necessary to purchase the capacity. The offering 10 may be underwritten by the same financial institution, banks, large corporate buyers, and traditional underwriters having a consumer focus.

The initial sale and purchase process of the offering 10 resembles a commodity futures-type system in which the owner of the capacity wishes to hedge the financial risk of holding the seat miles 12 by selling a portion of the seat miles 12 for future consumption by a variety of interested purchasers. Desirably, the initial offering 10 of the seat miles 12 occurs at a specific time and place (e.g., the closing) subject to the Uniform Commercial Code statutes governing the practices ordinarily and customarily associated with commodity trading and other relevant commercial practices. The size of the offering 10 may be any size that is economically and financially justifiable to the carrier or issuer. A traditional pre-negotiated underwriting and selling agent spread may be associated with the sale of the seat miles 12. For example, it is envisioned that the underwriter to the offering 10 will take a financial risk spread of 0.5 to 3.0%, depending on the financial strength of the carrier and the risk of the carrier in not being able to perform at the time the seat miles 12 are to be utilized. Spreads may rise subject to negotiation between the carrier and the underwriter. Selling concessions may be made by the underwriter to re-marketers, agents, sales organizations, and others who are solicited to move fractional parts of the initial bulk of seat miles 12 issued.

It is to be understood that seat miles 12 may be rated in the same manner as any other financial product sold to the public. Based on the given issuer's strength, the seat miles 12 would be rated accordingly. Most likely, it is envisioned that the ratings associated with the seat miles 12 would not impact the price of the seat miles 12 sold. Rather, the ratings would impact the cost of default or “failure to perform” bonds needed to facilitate underwriting transactions. Such calculations and methods of procedure are highly evolved in both the debt rating and municipal bond insurance industries and would be transferable “best practice” methods for application to the aforementioned capacity marketing business method.

Desirably, the carrier receives cash at a negotiated price and the purchaser receives the rights to use or re-market the carrier's seat miles 12 in units agreed to within the terms of the bulk sale or underwriter's agreement. Such terms would dictate a time period for which the seat miles 12 are available, as well as any terms for a given issuance of the seat miles 12 including, but not limited to, an expiration date if not used by a certain date in the future, conversion rights to utilize similar units on other carriers or in other ways, transfer rights, bundling rights for special purposes, and premium service alternatives (e.g., double utilization for preferred seating, service, etc.).

After the seat miles 12 have been purchased by the underwriters 16, or any other purchaser, the seat miles 12 enter a distribution cycle 22 in which they are moved through various distribution channels. The distribution channels into which the seat miles 12 are moved depend on whom is included in the syndicate of the purchasing underwriters 16. For example, as shown in FIG. 1, the underwriters 16 may distribute the seat miles 12 to sales syndicates 24 and mega agencies 26, such as large travel consolidators or vacation packagers. On-line travel companies 20 may repackage the bulk purchases of seat miles 12 into more fungible units of sale and then re-market the seat miles 12 to the general public, such as consumers 28 and end-users 30. Other participants in the distribution cycle may be brokerage firms 32 specializing in commodities. Each participant in the various distribution channels may have a different risk-to-reward incentive and is free to price its reofferings to reflect that incentive. For example, the underwriters 16 may determine a spread or commission incentive to compensate for the risks of not being able to immediately redistribute all the seat miles 12 purchased and to compensate for holding the seat miles 12 as inventory at risk. As another example, a travel agent in a local market may want to hold inventory for markup because the travel agent's local clientele is willing to “pay up” for special attention and services.

After having been moved into the distribution channels, the seat miles 12 become part of sales and exchange activities 34 in the commodities market. Some of the associated sales and exchange activities 34 may involve the purchase and resale of the seat miles 12 to individual travel agents and booking firms. Additionally, entities of the distribution cycle may market future contracts involving the seat miles 12 to travel service firms, hotel chains, and large business customers. Furthermore, the seat miles 12 may be sold to individual consumers bidding for low cost travel through an auction system or to highly valued frequent travelers of the carriers. In much the same way that retail brokerage houses (e.g., Merrill Lynch®, Charles Schwab®, Prudential®, etc.) would lend a distinct retail flavor to a securities underwriting and an institutional firm such as Goldman Sachs® or First Boston®, would favor institutional distribution, so too would the strong presence of an on-line travel system be more directed toward consumer sales, and the participation of a “mega” travel agency, such as Rosenbluth®, would likely favor large institutional sales to Fortune 500® companies.

It is to be understood that any of the sales and exchange activities 34 may involve settlement as part of the transaction. All settlements would be consistent with present clearing and settlement process and timeliness in effect for underwriting, distributing, selling, trading, and canceling trades of securities, securitized products, commodities, and other financial instruments including options, derivatives, and all manner of future contracts. The same settlement house used for stock exchanges, commodities, and mercantile transactions may be used for seat miles 12. It is envisioned that the commodity settlements infrastructure, together with appropriate self-regulating organizations, would apply existing standards for clearing and settlements or would develop new standards when warranted. For example, this may include using CUSIP numbers or other unique security indentifiers commonly used to facilitate backoffice clearing and settlements.

If a purchaser of the seat miles 12 wishes to sell or trade non-standard contract units of a given issue, he/she may do so through “odd lot” purchases and sales similar to trading less than 100-share blocks of stock on most securities exchanges. Other commoditized units of capacity may also be packaged to lend themselves to individual account-type management needs of ultimate end-users. Most likely, small retail travel agencies and individual capacity brokers will provide the most liquidity for the “odd lot” market.

The sales and exchange activities 34 of the seat miles 12 are eventually subject to termination 36 of the seat miles 12. Termination 36 within the commodities market encompasses the purchase of the seat miles 12 and the utilization thereof, the expiration of the seat miles 12 without value, or the repurchase of the seat miles 12 by the offering carrier. It is envisioned that after any purchase of the seat miles 12 by the ultimate end-user, the seat miles 12 would reside in the end-user's account, such as a seat mile account, and be drawn down for utilization in much the same way that frequent flyer or frequent guest accounts are managed. Thus, utilization may be viewed as redeeming a commodity unit for air travel.

As shown in FIG. 1, the distribution cycle begins with direct purchase from the carriers and ends with sale to various intermediaries who participate in the exchange-based system of trading and resale to end-users. There are many participants with multiple reasons to participate. At one end of the spectrum are businesses that wish to ensure a steady and affordable supply of product (e.g., vacation packages, convention firms, booking agents). At the other extreme are speculators who hope to profit by selling their seat miles 12 to other consumers or businesses before they expire.

The economic incentives for individual carriers in the air transportation system to adopt this invention and participate within the system it describes are manyfold. First, a financial risk of the carrier's overall business is reduced by the advance sale of capacity into a marketplace where capacity utilization is highly volatile and fluctuates wildly in response to a myriad of factors including political events, economic conditions, energy prices, and consumer confidence. A profit margin for the carrier utilizing the present invention may be easily calculated. For example, a carrier with an estimated annual carrying capacity of 10 billion seat miles (i.e., the deployed, in-place aircraft fleet capability to fly passengers 10 billion miles on its current routing mix) may wish to forward sell 20% of that capacity at a guaranteed profit of 100%. If the given carrier's cost per seat mile is $0.14/mile, then the capacity may be sold at $0.28/mile, yielding $560,000,000 cash in advance to the selling (hedging) carrier. The seat miles would, in this example, be good for one year's duration, conforming to the carrier's fiscal year, although it is to be understood that issuances can be made for longer or shorter periods, depending on the needs and marketing strategy of the carrier. Second, the sale and purchase of this capacity would be negotiated between the carrier and a primary underwriter or underwriting syndicate for direct sale to the end-users or other intermediaries who service the traveling public. In select cases a carrier may wish to have a direct capacity auction without the use of an underwriting syndicate. In any case, the carrier realizes the benefit of having some control over, and guaranteed profitability for, a portion of its capacity. Third, the participants in the air transportation system can hedge risk and at the same time even repurchase capacity through the exchange-based intermediary system.

It is envisioned that the primary marketplace conducive to the present invention is the multi-million dollar travel market, involving business travelers in search of rational pricing for air travel, hotels, and other components of travel as well as leisure and vacation travelers in search of consistent and fair prices in travel and rental markets. In addition to the financial and operating benefits realized by the carriers, many features are attractive and beneficial to intermediary market participants in the post-distribution exchange-based trading activities. The institutional or intermediary market participants may include ticket consolidators, mega travel agencies, resort and time share marketers, hotel chains, rental car companies, event and convention planners and packagers, tourist bureaus, and state, local, and federal governmental agencies. On-line booking services can become “principals” to sales and purchase transactions by actually owning travel inventory, such as the seat miles, for resale or usage by their own internal operations or bundling with other services, such as car rentals, hotel rooms and vacation packages. Independent travel agencies, already threatened with extinction by the air transportation industry's own direct sales efforts, can become revitalized by taking risks of seat mile ownership in order to gain control over prices to their local and frequent customers. Commodity brokers and speculators would earn profits by trading seat miles based on their short term demand forecasts. Their presence would also improve the aftermarket liquidity and pricing mechanisms for seat mile sales, resales, purchases, and repurchases. Commodity brokers may also act as fronting agents to repurchase capacity for carriers. Large travel and booking businesses which represent large clients would be able to provide new kinds of cost saving services.

It is envisioned that the present invention is practiced in a computer network-based environment, e.g., the Internet, wherein the entities involved, e.g., carriers, underwriters, end-users, commodities markets, are communicatively connected to each other. For example, a travel service provider, such as Travelocity® or Priceline.com®, may be one of the distribution channels through which the seat miles are moved. Each travel service provider usually contracts with a global distribution system, such as Worldspan®, Galileo®, or SABRE®, to provide clearinghouse services between the travel service provider and the carriers. The global distribution system therefore has access to various databases necessary to complete a booking or reservation for a traveler. The databases may be local to the global distribution system, such as a database containing frequent flyer mile accounts, or they may be accessed from a third party. For example, the third party, such as a seat miles clearinghouse, may be responsible for managing a database containing the seat mile accounts of end-users. The traveler may be an end-user who has amassed a number of seat miles which he or she wishes to use in acquiring his or her ticket. This may be in addition to or in lieu of other payment, such as cash or credit. Therefore, if the traveler indicates in his or her booking through the travel service provider that they would like to use all or some of their seat miles as a form of payment, the global distribution system would access the database of the seat miles clearinghouse in order to draw down for utilization the appropriate number of seat miles of the end-user. It is to be understood that the seat miles clearinghouse may also partake in any other aspect of the present invention. For example, the seat miles clearinghouse may be involved in the original offering of the seat miles from the carrier to the underwriter. In this case, the commodity units, as represented by the financial instruments, may remain with the seat miles clearinghouse up through utilization thereof. It is also envisioned that as a substitute to the seat miles clearinghouse, any carrier may manage a seat miles database themselves, which the global distribution system may directly access.

It is to be understood that the possibilities for this exchange-based seat mile distribution system are endless in terms of the financial products, derivative products, bundled products and methods for the air transportation industry to improve its overall capacity yield and, commensurately, its profitability and ability to match long-term fixed costs with more stable revenue streams. For example, although the present invention may be implemented on a large scale through the major airline carriers, seat miles may also be commoditized for private jet service.

In an alternative embodiment to the use of seat miles as the capacity unit, the aforementioned capacity marketing concepts may be applied to any end-use consumer situation where there is a need to market capacity (variable or fixed) or to convert fixed capacity into presold revenue that would otherwise be lost. For example, commoditization solutions and revenue opportunities would be represented in the lodging industry by unsold room nights, or in the car rental business by unsold fleet rental days, or in other consumer end-use products or services typically underwritten or reimbursed by businesses. Therefore, any such service capacity would be partitioned into a plurality of capacity units so that each of the capacity units would be representative of a portion of that service capacity.

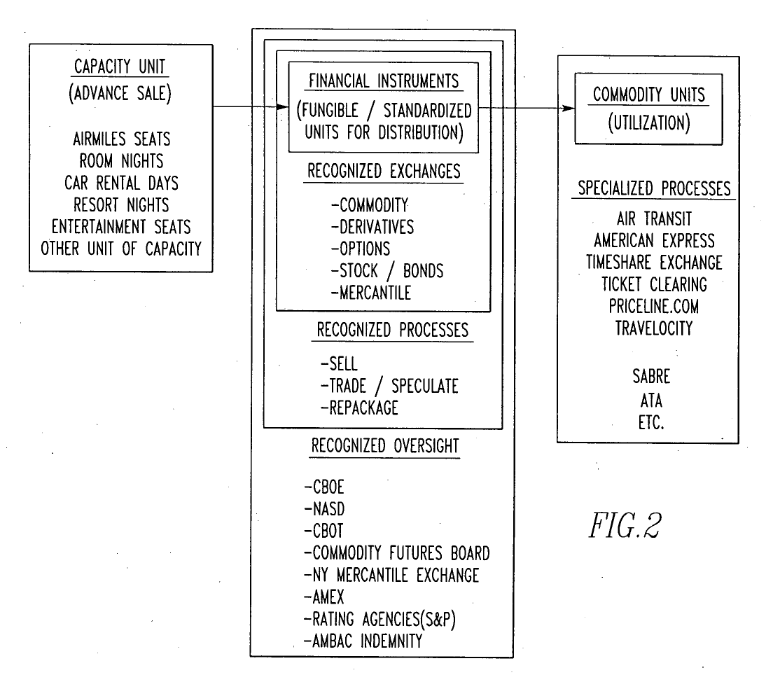

FIG. 2 is a schematic diagram showing the transmutation of any such capacity unit into a commodity unit. One or more of the underlying capacity units of each industry is represented by a financial instrument or capacity contract containing the terms associated with the capacity unit. Each of the commodity units would exist in one or more of the recognized exchanges including, but not limited to, the commodity, derivatives, options, stock/bond, and mercantile exchanges. Recognized processes would be conducted in the recognized exchanges including, but not limited to, selling, trading, speculating, and repackaging of the financial instruments. The commodities market in which the commodity units exist, would operate and be regulated under recognized oversight from various market regulating bodies. Prior to the reaching the final mode of utilization, it is envisioned that the commodity units remain in the form of financial instruments subject to handling through appropriate standardized regulation and rules of fair practice. Existing regulations are sufficiently evolved to govern seat miles or any other type of capacity sale. Upon exiting the commodities market and owned by the ultimate end-user, the commodity unit is ready for utilization. Upon entering utilization, the commodity unit is subject to processing by mechanisms appropriate for handling transactions within the framework of the marketplace where utilization will occur. Thus, the commodity unit may be utilized in any of the specialized processes offered by the respective industry for which the capacity unit was issued in the initial offering.

Although the concept of commodities and commoditization are already known, the benefits of taking consumer products and redefining them so as to make them fungible, for the purpose of commoditizing them for bulk purchase and resale to end-use consumers, is novel with the present invention.

The invention has been described with reference to the desirable embodiments. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A method for marketing air travel services for a carrier in an air transportation system, the method comprising the steps of:
purchasing a capacity unit from the carrier, wherein the capacity unit corresponds to a fixed distance of air travel to be traveled by a passenger of the carrier;
offering for purchase the capacity unit as a commodity unit in a commodity market; and
selling the commodity unit in the commodity market.

2. The method of claim 1, wherein the capacity unit is a seat mile, wherein the seat mile has a seat cost associated therewith, and wherein the seat cost is determined by the cost to fly the passenger for one mile.

3. The method of claim 1, wherein the seat cost is further determined by a plurality of load factors.

4. The method of claim 1, wherein the capacity unit is exchangeable between the carrier and another carrier.

5. The method of claim 1, wherein the capacity unit is fungible for various classes of service.

6. The method of claim 1, wherein the capacity unit is fungible for non-air travel specific services.

7. The method of claim 1, wherein the capacity unit includes a fixed period of validity associated therewith.

8. The method of claim 1, wherein the capacity unit is one of (a) rated, and (b) insured.

9. The method of claim 1, wherein the capacity unit is represented as a financial instrument in the commodity market.

10. The method of claim 1, wherein the commodity unit is utilized to obtain the capacity unit within the air transportation system.

11. The method of claim 1, wherein the capacity unit is sold by the carrier to one of (a) an underwriter, (b) financial service firm, (c) an on-line travel product company, (d) an investment bank, and (e) a brokerage house.

12. The method of claim 11, wherein the capacity unit is resold through distribution channels in a distribution cycle.

13. The method of claim 12, wherein the capacity unit is sold to an end-user, wherein the end-user utilizes the capacity unit.

14. The method of claim 11, wherein the capacity unit is sold back to the carrier.

15. A method for marketing air travel services for a carrier in an air transportation system, the method comprising the steps of:
establishing a plurality of capacity units, wherein each capacity unit corresponds to a fixed distance of air travel to be traveled by any passenger;
selling the plurality of capacity units, wherein the plurality of capacity units is sold as a plurality of commodity units in a commodity market; and
providing air travel for a passenger who has redeemed at least one of the commodity units.

16. The method of claim 15, wherein the capacity unit is a seat mile, wherein the seat mile has a seat cost associated therewith, and wherein the seat cost is determined by the cost to fly the passenger for one mile.

17. A method for marketing a service capacity, the method comprising selling the service capacity, wherein the service capacity is partitioned into a plurality of capacity units, and wherein the plurality of capacity units is sold on an exchange.

18. The method of claim 17, wherein the exchange is a commodity market.

19. The method of claim 18, wherein the plurality of capacity units is sold as a plurality of commodities.
